(19) United States
(12) Patent Application Publication
(10) Pub. No.: US 2019/0203076 A1
(43) Pub. Date: Jul. 4, 2019

(54) Hot Melt Adhesive Film Bonding Rubber and Ethylene-Vinyl Acetate (EVA) Foam

(71) Applicants: Yuh-Jye Uang, Taichung City (TW); Chi-Shih Lee, Taichung City (TW)

(72) Inventors: Yuh-Jye Uang, Taichung City (TW); Chi-Shih Lee, Taichung City (TW)

(21) Appl. No.: 16/353,196

(22) Filed: Mar. 14, 2019

Related U.S. Application Data
(63) Continuation-in-part of application No. 15/432,960, filed on Feb. 15, 2017.

(51) Int. Cl. C09J 7/35; C09J 5/06; C09J 11/08; C09J 11/04; C09J 11/06; C08J 5/12; B32B 7/06

(52) U.S. Cl. CPC C09J 7/35; C08J 2321/00; C09J 11/08; C09J 11/04; C09J 11/06; C08J 5/128; B32B 7/06; C09J 2205/102; C09J 2205/114; C09J 2423/04; C09J 2433/00; C09J 2407/00; C09J 2409/00; C09J 2411/00; C09J 2423/16; C09J 2400/246; C09J 2423/048; C09J 2431/008; C09J 2421/008; C08J 2323/08; C08J 2329/14; C09J 5/06

(57) ABSTRACT

A hot melt adhesive film for bonding an ethylene-vinyl acetate form and a rubber includes a hot melt adhesive film layer and a release film layer. The hot melt adhesive film layer is prepared by the following raw materials in parts by weight: a 20-50 parts by weight of polyethylene-ester copolymer, a 5-15 parts by weight of rubber, a 15-55 parts by weight of thermoplastic polyolefin, a 5-20 parts by weight of tackifier and a 5-30 parts by weight of auxiliary. The release film layer is releasably adhered to the hot melt adhesive film layer.

### CROSS REFERENCE TO RELATED APPLICATION

The present application is a continuation-in-part application of U.S. patent application Ser. No. 15/432,960 filed on Feb. 15, 2017, of which the entire disclosure is incorporated herein.

### BACKGROUND OF THE INVENTION

### 1. Field of the Invention

The present invention relates to a hot melt adhesive film and, particularly, to a hot melt adhesive film bonding a rubber and an ethylene-vinyl acetate (EVA) form. The melting point of hot melt adhesive film is higher than the 70° C. to prevent the adhesion failure between EVA foam and rubber article during the sea freight.

### 2. Description of the Related Art

U.S. Pat. No. 8,568,548 discloses a method of manufacturing footwear using adhesive films and a composite of adhesive films. The method includes a use of a composite of the adhesive films to bond an EVA midsole and a rubber outsole. There is no disclose of heat resistance about the hot melt adhesive film.

It is difficult to use one adhesive film only to bond the EVA midsole and the rubber outsole together. However, the more adhesive films and processes needed, the higher the cost of manufacture.

The present invention is, therefore, intended to obviate or at least alleviate the problems encountered in the prior art.

### SUMMARY OF THE INVENTION

According to the present invention, a hot melt adhesive film for bonding an ethylene-vinyl acetate foam and a rubber includes a hot melt adhesive film layer and a release film layer. The hot melt adhesive film layer is prepared by the following raw materials in parts by weight: a 20-50 parts by weight of polyethylene-ester copolymer, a 5-15 parts by weight of rubber, a 15-55 parts by weight of thermoplastic polyolefin, a 5-20 parts by weight of tackifier, and a 5-30 parts by weight of auxiliary. The release film layer is releasably adhered to the hot melt adhesive film layer.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

It is an objective of the present invention to provide a hot melt adhesive film for bonding an ethylene-vinyl acetate copolymer (EVA) foam and a rubber effortlessly, with fewer processes, economically, with fewer materials needed, and effectively, better than conventional adhesives.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a cross-sectional view of a hot melt adhesive film for bonding an ethylene-vinyl acetate (EVA) foam and a rubber in accordance with the present invention.

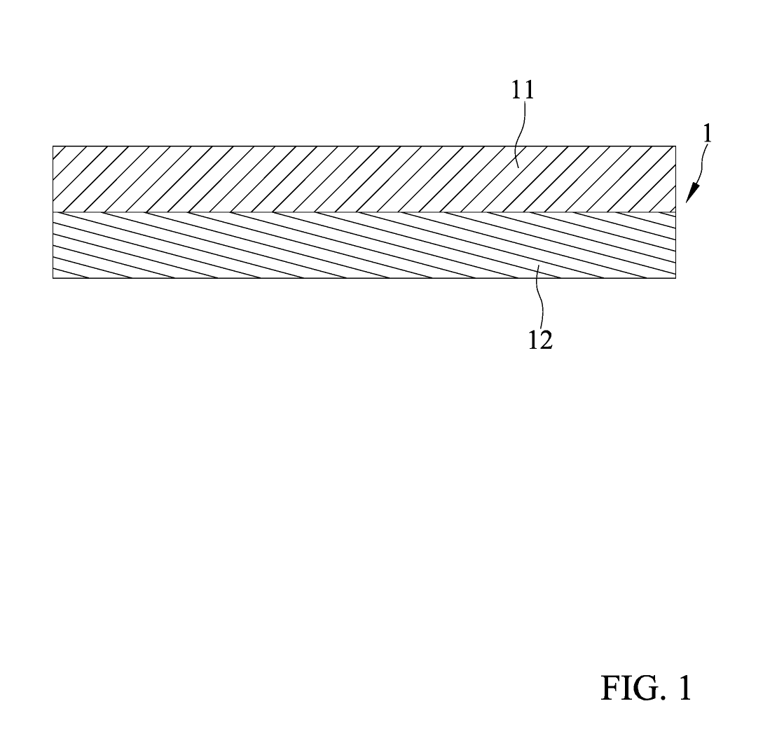

FIG. 2 is a cross-sectional view showing the ethylene-vinyl acetate (EVA) foam and the rubber bonded by the hot melt adhesive film layer of the hot melt adhesive film.

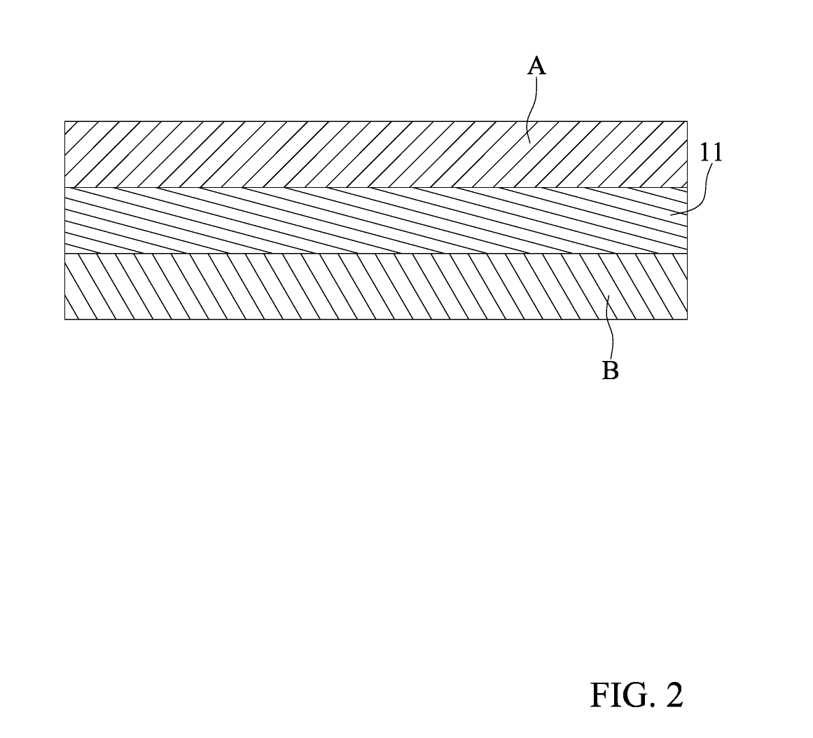

### DETAILED DESCRIPTION OF THE INVENTION

A hot melt adhesive film 1 for bonding an ethylene-vinyl acetate foam A and a rubber article B includes a hot melt adhesive film layer 11 and a release film layer 12.

The hot melt adhesive film layer 11 is prepared by the following raw materials in parts by weight: a 20-50 parts by weight of polyethylene-ester copolymer, a 5-15 parts by weight of rubber, a 15-55 parts by weight of thermoplastic polyolefin, a 5-20 parts by weight of tackifier, and a 5-30 parts by weight of auxiliary.

Preferably, the polyethylene-ester copolymer is 25-40 parts by weight. Preferably, the rubber is 10-20 parts by weight. Preferably, the thermoplastic polyolefin is 30-50 parts by weight. Preferably the tackifier is 10-25 parts by weight. Preferably, the auxiliary is 10-20 parts by weight.

The polyethylene-ester copolymer is one of the following kinds: a polyethylene-vinyl acetate copolymer, a polyethylene methyl acrylate copolymer, a polyethylene ethyl acrylate copolymer, a butyl acrylate copolymer, or a blend of at least two said kinds thereof. Preferably the melting point of polyethylene ester copolymer is above 100° C.

The rubber is a natural rubber, a synthetic rubber, or a blend of said natural rubber (NR) and said synthetic rubber. Said synthetic rubber is one of the following kinds: a chloroprene rubber (CR), a styrene-butadiene rubber (SBR), a polybutadiene rubber (BR), an acrylonitrile butadiene rubber (NBR), a polyisoprene rubber (IR), an isobutylene isoprene butyl rubber (IIR), an ethylene propylene copolymer (EPR), an ethylene propylene diene monomer (EPDM), or a blend of at least two said kinds thereof.

The thermoplastic polyolefin is one of the following kinds: an ethylene propylene copolymer, an ethylene propylene diene terpolymer, an ethylene butylene copolymer, and an ethylene octene copolymer, or a blend of at least two said kinds thereof. Preferably the melting point of thermoplastic polyolefin is above 100° C.

The tackifiers is one of the following kinds: a rosin ester, a polymerized rosin, a terpene, a styrene terpene, a polyterpene phenolic resin, a petroleum resin, a modified petroleum resin, or a blend of at least two said kinds thereof. Preferably the melting point of tackifier is above 100° C.

The auxiliary is one of the following kinds: a plasticizer, a filler, a rubber vulcanizing accelerator, a rubber activator, a softener, a rubber scorch retarder, a crosslinking agent, an antiozonant, an antioxidant, a vulcanizing agent, or a blend of at least two said kinds thereof.

The plasticizer is one of the following kinds: a mineral oil, a polybutylene, an isoprene rubber, or a blend of at least two said kinds thereof.

The filler is one of the following kinds: a kaolin, a mica, a titanium dioxide, a silica, a talc, a carbon black, a reclaimed rubber or a blend of at least two said kinds thereof.

The rubber vulcanizing accelerator is one of the following kinds: a thiazole vulcanization accelerator, a sulfonamide type, a guanidine type, a dithio carbamate type, a thiourea type, a thiurams type, or a blend of at least two said kinds thereof.

The rubber activator is one of the following kinds: a zinc oxide, a magnesium oxide, a calcium oxide, a stearate, or a blend of at least two said kinds thereof.

The softener is one of the following kinds: a mineral oil, a liquid paraffin, a linseed oil, coco oil, a paraffin, a carnauba wax, a stearate, a palmitic acid, or a blend of at least two said kinds thereof.

The rubber scorch retarder is one of the following kinds: a phthalic anhydride, a salicylic acid, a benzoic acid, a N-nitrosodiphenylamine, a phthalic imide sulfenamide or a blend of two or more of said kinds.

The antiozonant is one of the following kinds: a microcrystalline wax, a paraffin, a natural asphalt, or a blend of at least two said kinds thereof.

The catalyst is dibutyl tin dilaurate.

The antioxidant is one of the following kinds: a N-(1,3-Dimethylbutyl), a N′-phenyl-p-phenylenediamine (6PPD), a diphenyl-p-phenylenediamine (DPPD), an octylated diphenylamine (ODPA), a 2-mercapto-benzimidazole (MB), a 2,6-Di-tert-butyl-4-methylphenol (BHT), or a blend of at least two said kinds thereof.

The crosslinking agent is one of the following kinds: a dicumyl peroxide, a 1,1-Bis(t-butylperoxy)3,3,5-trimethyl-cyclohexane, a tert-buytlperoxy-2-ethylhexyl carbonate, a tert-butyl cumylperoxide, or a blend of at least two said kinds thereof.

The vulcanizing agent is sulfur or sulfur donor vulcanizing agent for example: a solubilized sulfur, a 4,4′-dithiodimorpholine.

The silane coupling agent is one of the following kinds: n-octyltriethoxysilane, a (3-glycidoxypropyl) methyldiethoxysilane, derivatives of triethoxysilane, a sodium polysulphide, or a blend of at least two said kinds thereof.

The release film layer 12 is releasably adhered to the hot melt adhesive film layer.

In the embodiment, 60 kg of polyethylene-ester copolymer, 20 kg of a natural rubber, 5 kg of a thermoplastic polyolefin, 4 kg of a tackifier, 0.7 kg of a stearic acid, 1.5 kg of a microcrystalline wax, 1 kg of a zinc oxide, 0.6 kg of sulfur, a mixture of 0.35 kg of a 2,2′-dibenzothiaolyl disulfide (MBTS) and 0.2 kg of an Irganox® 1010 antioxidant are kneaded by a kneader. Then, a combined mixture of set forth ingredients are calendered to produce a unvulcanized hot melt adhesive film.

The procedure of using the hot melt adhesive film 1 to bond an ethylene-vinyl acetate copolymer (EVA) foam A and a rubber B includes removing the release film layer 12 from the hot melt adhesive film layer 11; positioning a first side of the hot melt adhesive film layer 11 on the rubber B; hot pressing the hot melt adhesive film layer 11 and the rubber B; positioning the ethylene-vinyl acetate copolymer (EVA) foam A on a second side of the hot melt adhesive film layer 11; and hot pressing the ethylene-vinyl acetate copolymer (EVA) foam A, the hot melt adhesive film layer 11, and the rubber B to bond them together.

In view of the foregoing, with the hot melt adhesive film 1, the ethylene-vinyl acetate copolymer (EVA) foam A and the rubber B can be interconnected effortlessly, with fewer processes, economically, with fewer materials needed, and effectively, better than conventional adhesives.

The foregoing is merely illustrative of the principles of this invention, and various modifications can be made by those skilled in the art without departing from the scope and spirit of the invention.

What is claimed is:

1. A hot melt adhesive film for bonding ethylene-vinyl acetate (EVA) foam and a rubber article comprising:
a hot melt adhesive film layer prepared by the following raw materials in parts by weight: a 20-50 parts by weight of polyethylene-ester copolymer, a 5-15 parts by weight of rubber, a 15-55 parts by weight of thermoplastic polyolefin, a 5-20 parts by weight of tackifier, and a 5-30 parts by weight of auxiliary; and
a release film layer releasably adhered to the hot melt adhesive film layer (11).

2. The hot melt adhesive film according to claim 1, wherein said polyethylene-ester copolymer is 25-40 parts by weight, said rubber is 10-20 parts by weight, said thermoplastic polyolefin is 30-50 parts by weight, said tackifer is 10-25 parts by weight, and said auxiliary is 10-20 parts by weight.

3. The hot melt adhesive film according to claim 1, wherein said polyethylene-ester copolymer is at least one selected from the group consisting of kinds: a polyethylene-vinyl acetate copolymer, a polyethylene methyl acrylate copolymer, a polyethylene ethyl acrylate copolymer, a butyl acrylate copolymer, or a blend of at least two said kinds thereof, and wherein the melting point of polyethylene ester copolymer is above 100° C.

4. The hot melt adhesive film according to claim 1, wherein said rubber is at least one selected from the group consisting of kinds: natural rubber, synthetic rubber, or a blend of said natural rubber and said synthetic rubber, and wherein said synthetic rubber is at least one selected from the group consisting of kinds: a chloroprene rubber (CR), a styrene-butadiene rubber (SBR), a polybutadiene rubber (BR), an acrylonitrile butadiene rubber (NBR), a polyisoprene rubber (IR), an isobutylene isoprene butyl rubber (IIR), an ethylene propylene diene monomer (EPDM), or a blend of at least two said kinds thereof.

5. The hot melt adhesive film according to claim 1, wherein said thermoplastic polyolefin is at least one selected from the group consisting of kinds: an ethylene propylene copolymer, an ethylene propylene diene terpolymer, an ethylene butylene copolymer, and an ethylene octene copolymer, or a blend of at least two said kinds thereof, and wherein the melting point of thermoplastic polyolefin is above 100° C.

6. The hot melt adhesive film according to claim 1, wherein said tackifier is at least one selected from the group consisting of kinds: a rosin ester, a polymerized rosin, a terpene, a styrene terpene, a polyterpene phenolic resin, a petroleum resin, a modified petroleum resin, or a blend of at least two said kinds thereof, and wherein the melting point of tackifier is above 100° C.

7. The hot melt adhesive film according to claim 1, wherein said auxiliary is at least one selected from the group consisting of kinds: a plasticizer, a filler, a rubber vulcanizing accelerator, a rubber vulcanizing agent, a rubber activator, a softener, a rubber scorch retarder, a crosslinking agent, an antiozonant, an antioxidant, an additive, or a blend of at least two said kinds thereof, and wherein said additive is vulcanizator or silane coupling agent.

8. The hot melt adhesive film according to claim 7, wherein said plasticizer is at least one selected from the group consisting of kinds: a mineral oil, a polybutylene, an isoprene rubber, or a blend of at least two said kinds thereof.

9. The hot melt adhesive film according to claim 7, wherein said filler is at least one selected from the group consisting of kinds: a kaolin, a mica, a titanium dioxide, a silica, a talc, a carbon black, a reclaimed rubber or a blend of at least two said kinds thereof.

10. The hot melt adhesive film according to claim 7, wherein said rubber vulcanizing accelerator is at least one selected from the group consisting of kinds: a thiazole vulcanization accelerator, a sulfonamide type, a guanidine type, a dithio carbamate type, a thiourea type, a thiurams type, or a blend of at least two said kinds thereof.

11. The hot melt adhesive film according to claim 7, wherein said rubber activator is at least one selected from the group consisting of kinds: a zinc oxide, a magnesium oxide, a calcium oxide, a stearate, or a blend of at least two said kinds thereof.

12. The hot melt adhesive film according to claim 7, wherein said softener is at least one selected from the group consisting of kinds: a mineral oil, a liquid paraffin, a linseed oil, a coco oil, a paraffin, a carnauba wax, a stearate, a palmitic acid, or a blend of at least two said kinds thereof.

13. The hot melt adhesive film according to claim 7, wherein said rubber scorch retarder is at least one selected from the group consisting of kinds: a phthalic anhydride, a salicylic acid, a benzoic acid, a N-nitrosodiphenylamine, a phthalic imide sulfenamide or a blend of at least two said kinds thereof.

14. The hot melt adhesive film according to claim 7, wherein said antiozonant is at least one selected from the group consisting of kinds: a microcrystalline wax, a paraffin, a natural asphalt, or a blend of at least two said kinds thereof.

15. The hot melt adhesive film according to claim 7, wherein said crosslinking agent is at least one selected from the group consisting of kinds: a dicumyl peroxide, a 1,1-Bis(t-butylperoxy)3,3,5-trimethyl-cyclohexane, a tert-buytlperoxy-2-ethylhexyl carbonate, a tert-butyl cumylperoxide, or a blend of at least two said kinds thereof.

16. The hot melt adhesive film according to claim 7, wherein the antioxidant is at least one selected from the group consisting of kinds: a N-(1,3-Dimethylbutyl), a N′-phenyl-p-phenylenediamine (6PPD), a diphenyl-p-phenylenediamine (DPPD), an octylated diphenylamine (ODPA), 2-mercapto-benzimidazole (MB), a 2,6-Di-tert-butyl-4-methylphenol (BHT), or a blend at least two said kinds thereof.

17. The hot melt adhesive film according to claim 7, wherein said vulcanizing agent is sulfur or sulfur donor vulcanizing agent, wherein said sulfur donor vulcanizing agent is a 4,4′-dithiodimorpholine, and wherein silane coupling agent is at least one selected from the group consisting of kinds: a n-octyltriethoxysilane, a (3-glycidoxypropyl)methyldiethoxysilane, a derivatives of triethoxysilane, a sodium polysulphide, or a blend of at least two said kinds thereof.
